(19) United States
(12) Patent Application Publication
(10) Pub. No.: US 2024/0314425 A1
(43) Pub. Date: Sep. 19, 2024

(54) INFORMATION PROCESSING SYSTEM AND NON-TRANSITORY COMPUTER READABLE MEDIUM

(71) Applicant: FUJIFILM Business Innovation Corp., Tokyo (JP)

(72) Inventors: Hirotake SASAKI, Kanagawa (JP); Kiyoshi IIDA, Kanagawa (JP); Toshihiko SUZUKI, Kanagawa (JP)

(73) Assignee: FUJIFILM Business Innovation Corp., Tokyo (JP)

(21) Appl. No.: 18/454,117

(22) Filed: Aug. 23, 2023

(30) Foreign Application Priority Data
Mar. 14, 2023 (JP) 2023-039322

(51) Int. Cl. H04N 23/60

(52) U.S. Cl. CPC H04N 23/64

(57) ABSTRACT

An information processing system includes an operator apparatus that photographs an object; and a supporter apparatus that supports an operation by an operator who uses the operator apparatus. The supporter apparatus includes a first processor. The operator apparatus includes a second processor. The first processor is configured to: perform control in such a manner that a first screen representing a three-dimensional model of the object is displayed on a display device; and receive a designation of display contents on the first screen. The second processor is configured to virtually display, via the operator apparatus, information indicating a position and a posture of the operator apparatus corresponding to the display contents designated on the first screen.

### CROSS-REFERENCE TO RELATED APPLICATIONS

This application is based on and claims priority under 35 USC 119 from Japanese Patent Application No. 2023-039322 filed Mar. 14, 2023.

### BACKGROUND

### (i) Technical Field

The present disclosure relates to an information processing system and a non-transitory computer readable medium.

### (ii) Related Art

A system that displays an image captured by an operator apparatus on a display for a supporter who supports an operation by an operator who uses the operator apparatus has been known. For example, the supporter may remotely support an operation by the operator.

In Japanese Unexamined Patent Application Publication No. 2006-209664, a method for acquiring a stereo image of a first stereo imaging unit worn by a first user, acquiring a second stereo image based on a stereo image of a second stereo imaging unit installed in a space where the first user is present and a virtual object image of the second stereo imaging unit, and presenting an image selected by a second user to the second user, is described.

In Japanese Unexamined Patent Application Publication No. 2016-35742, a system that acquires the position and the orientation of a head mount display in the real space, identifies a position in a virtual space on the basis of the position and the orientation in the real space, and displays an arrow from the head mount display for the identified position, is described.

In Japanese Unexamined Patent Application Publication No. 2021-10101, a system that includes a first display apparatus worn by a first user, a surrounding imaging apparatus disposed in a work site, and an information processing apparatus operated by a second user, is described. The first display apparatus transmits first image data to the information processing apparatus. The surrounding imaging apparatus transmits second image data to the information processing apparatus. The information processing apparatus displays the first image data and the second image data, and transmits data entered by the second user using an operation unit to the first display apparatus.

### SUMMARY

In the case where an operator performs photographing using an operator apparatus, a supporter may provide an instruction using sound for the position at which the operator apparatus is to be arranged and the posture that the operator apparatus is to have. However, it is difficult for the supporter to guide the operator to the position and the posture by using only sound.

Aspects of non-limiting embodiments of the present disclosure relate to, in a case where a supporter supports an operation by an operator who uses an operator apparatus, visually guiding the operator to a position at which the operator apparatus is to be arranged and a posture that the operator apparatus is to have.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing system including an operator apparatus that photographs an object; and a supporter apparatus that supports an operation by an operator who uses the operator apparatus, wherein the supporter apparatus includes a first processor, wherein the operator apparatus includes a second processor, wherein the first processor is configured to: perform control in such a manner that a first screen representing a three-dimensional model of the object is displayed on a display device; and receive a designation of display contents on the first screen, and wherein the second processor is configured to virtually display, via the operator apparatus, information indicating a position and a posture of the operator apparatus corresponding to the display contents designated on the first screen.

### BRIEF DESCRIPTION OF THE DRAWINGS

Exemplary embodiments of the present disclosure will be described in detail based on the following figures, wherein:

FIG. 1 is a block diagram illustrating a configuration of an information processing system according to an exemplary embodiment;

FIG. 2 is a block diagram illustrating a configuration of an operator apparatus according to an exemplary embodiment;

FIG. 3 is a block diagram illustrating a configuration of a supporter apparatus according to an exemplary embodiment;

FIG. 4 is a diagram illustrating a field and a remote location;

FIG. 5 is a diagram illustrating the field and the remote location;

FIG. 6 is a diagram illustrating the field and the remote location; and

FIG. 7 is a flowchart illustrating the flow of a process performed by the information processing system according to an exemplary embodiment.

### DETAILED DESCRIPTION

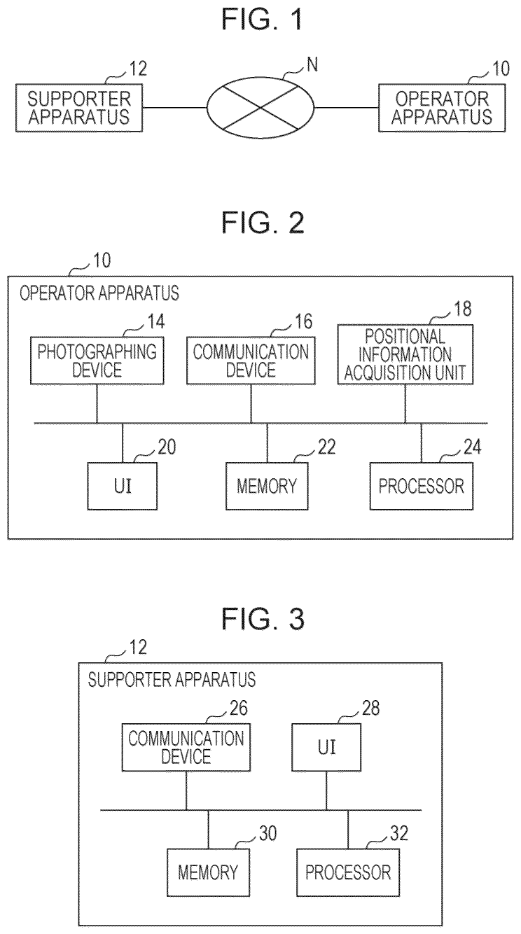

An information processing system according to an exemplary embodiment will be described with reference to FIG. 1. FIG. 1 is a block diagram illustrating an example of the configuration of an information processing system according to an exemplary embodiment.

The information processing system according to this exemplary embodiment includes an operator apparatus 10 and a supporter apparatus 12. The operator apparatus 10 and the supporter apparatus 12 each have a function for performing communication with an external apparatus. The communication may be wired communication or wireless communication. The wireless communication includes, for example, short-range wireless communication, Wi-Fi (registered trademark), and the like. Wireless communications other than the above standards may be used. For example, the operator apparatus 10 and the supporter apparatus 12 communicate with each other via a communication path N such as a local area network (LAN) or the Internet. The operator apparatus 10 and the supporter apparatus 12 may communicate with each other via an external apparatus such as a server.

Part of the functions of the operator apparatus 10 may be implemented by an external apparatus other than the operator apparatus 10. In this case, the operator apparatus 10 and the external apparatus may configurate an information processing system different from the above-mentioned information processing system, and all the functions of the operator apparatus 10 may be implemented by the information processing system.

Similarly, part of the functions of the supporter apparatus 12 may be implemented by an external apparatus other than the supporter apparatus 12. In this case, the supporter apparatus 12 and the external apparatus may configurate an information processing system different from the above-mentioned information processing system, and all the functions of the supporter apparatus 12 may be implemented by the information processing system.

The operator apparatus 10 is an apparatus used by an operator. For example, the operator apparatus 10 is a head mount display (HMD) such as smart glasses, a photographing apparatus such as a camera, a personal computer (PC), a tablet PC, a smartphone, or a mobile phone.

The supporter apparatus 12 is an apparatus used by a supporter who supports an operation by an operator. The supporter apparatus 12 is, for example, an HMD, a PC, a tablet PC, a smartphone, or a mobile phone.

For example, when an image (for example, a moving image or a still image) is captured by a camera of the operator apparatus 10, data of the image is transmitted from the operator apparatus 10 to the supporter apparatus 12 via the communication path N. The image is displayed on a display of the supporter apparatus 12. Furthermore, when sound such as voice is picked up by a microphone of the operator apparatus 10, data of the sound is transmitted from the operator apparatus 10 to the supporter apparatus 12 via the communication path N. The sound is output from a speaker of the supporter apparatus 12. The supporter references the image or listens to the sound and then provides an instruction to the operator.

For example, when the supporter operates the supporter apparatus 12 to provide an instruction to the operator, information indicating the instruction is transmitted to the operator apparatus 10 via the communication path N. The information indicating the instruction is output through the operator apparatus 10. For example, the information indicating the instruction is displayed on the display of the operator apparatus 10 or output as sound.

The supporter may support an operation by a single operator or support operations by a plurality of operators. For example, a plurality of operator apparatuses 10 may be included in the information processing system, and the supporter may provide instructions to the individual operators.

A hardware configuration of the operator apparatus 10 will be described below with reference to FIG. 2. FIG. 2 illustrates an example of the hardware configuration of the operator apparatus 10.

The operator apparatus 10 includes a photographing device 14, a communication device 16, a positional information acquisition unit 18, a user interface (UI) 20, a memory 22, and a processor 24.

The photographing device 14 is a camera and performs photographing to generate an image (for example, a moving image or a still image). For example, data of the image is transmitted to the supporter apparatus 12 via the communication path N.

The communication device 16 includes one or a plurality of communication interfaces each including a communication chip, a communication circuit, and the like and has a function for transmitting information to other apparatuses and a function for receiving information from other apparatuses. The communication device 16 may have a wireless communication function and may have a wired communication function.

The positional information acquisition unit 18 includes devices such as a global positioning system (GPS), an acceleration sensor, a gyroscope sensor, and a magnetic sensor and acquires positional information and posture information on the operator apparatus 10. The positional information is information indicating the position of the operator apparatus 10 in the real three-dimensional space. The posture information is information indicating the posture of the operator apparatus 10 (for example, the orientation and tilt of the operator apparatus 10) in the real three-dimensional space.

The UI 20 is a user interface and includes a display and an input device. The display is a liquid crystal display, an electroluminescence (EL) display, or the like. The input device includes a keyboard, a mouse, input keys, an operation panel, and the like. The UI 20 may be a UI such as a touch panel serving as both the display and the input device. The UI 20 also includes a microphone and a speaker.

The memory 22 is a device including one or a plurality of memory regions in which data are stored. The memory 22 is, for example, a hard disk drive (HDD), a solid state drive (SSD), a memory (for example, a random access memory (RAM), a dynamic random access memory (DRAM), a nonvolatile random access memory (NVRAM), a read only memory (ROM), or the like), other types of memory device (for example, an optical disc), or a combination of the above-mentioned devices.

The processor 24 controls operations of the units of the operator apparatus 10.

A hardware configuration of the supporter apparatus 12 will be described below with reference to FIG. 3. FIG. 3 illustrates an example of the hardware configuration of the supporter apparatus 12.

The supporter apparatus 12 includes a communication device 26, a user interface (UI) 28, a memory 30, and a processor 32.

The communication device 26 includes one or a plurality of communication interfaces each including a communication chip, a communication circuit, and the like and has a function for transmitting information to other apparatuses and a function for receiving information from other apparatuses. The communication device 26 may have a wireless communication function and may have a wired communication function.

The UI 28 is a user interface and includes a display and an input device. The display is a liquid crystal display, an EL display, or the like. The input device includes a keyboard, a mouse, input keys, an operation panel, and the like. The UI 28 may be a UI such as a touch panel serving as both the display and the input device. The UI 28 also includes a microphone and a speaker.

The memory 30 is a device including one or a plurality of memory regions in which data are stored. The memory 30 is, for example, an HDD, an SSD, a memory (for example, a RAM, a DRAM, an NVRAM, a ROM, or the like), other types of memory device (for example, an optical disc), or a combination of the above-mentioned devices.

The processor 32 controls operations of the units of the supporter apparatus 12.

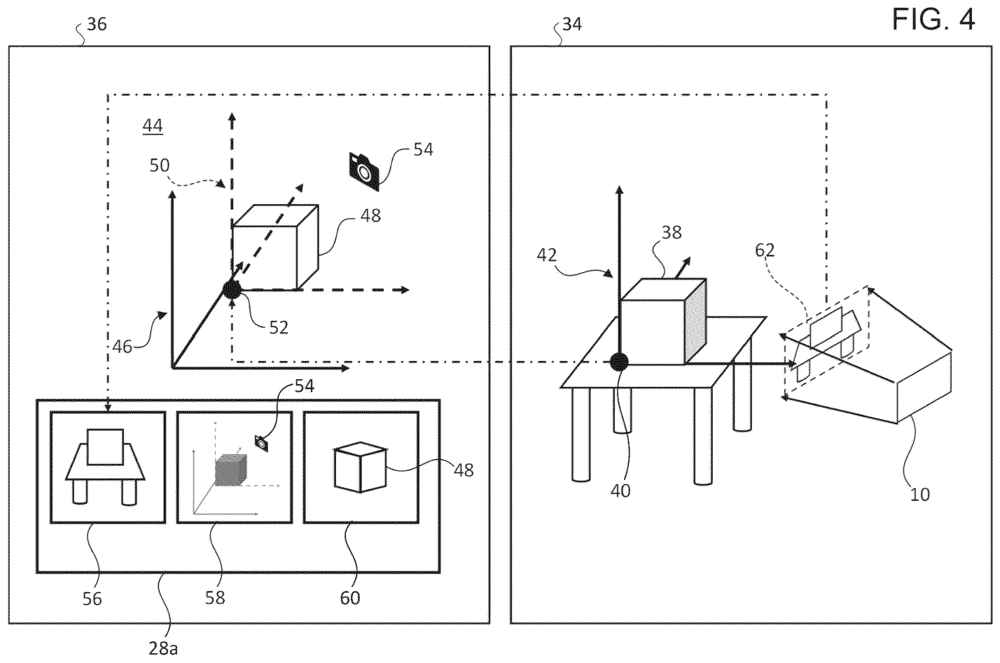

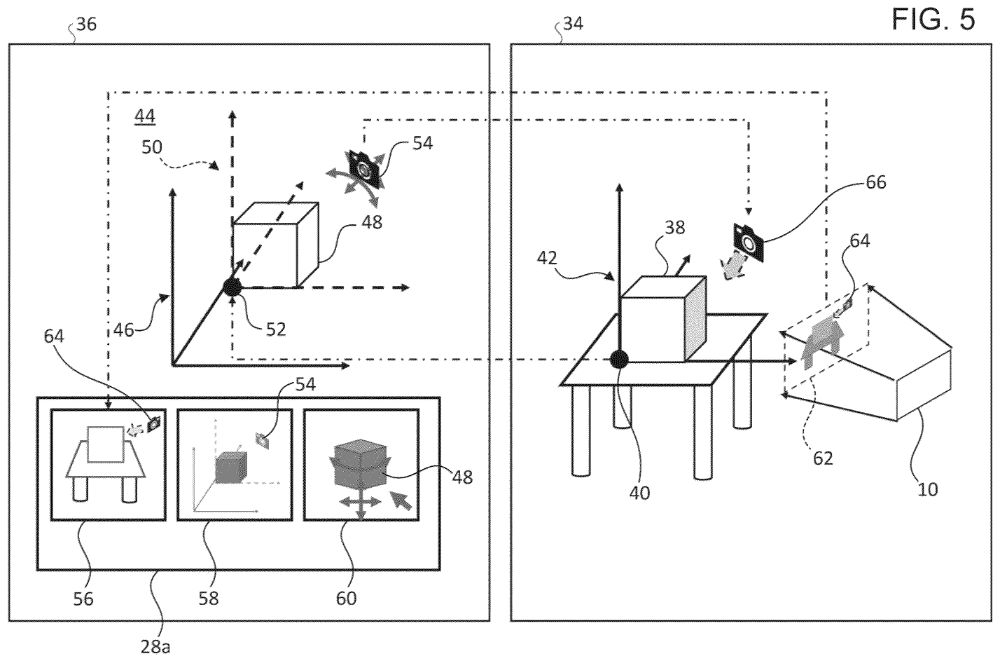

The information processing system according to an exemplary embodiment will be described in detail below with reference to FIG. 4. FIG. 4 illustrates a field 34 and a remote location 36.

The field 34 is a place where the operator performs an operation. In the example illustrated in FIG. 4, an operation object 38 is present in the field 34. In this example, the operator apparatus 10 is an HMD. The operator is wearing the operator apparatus 10 on the head and performs an operation in the field 34.

The remote location 36 is a place where the supporter supports an operation by the operator. The supporter apparatus 12 is installed at the remote location 36, and the supporter is present at the remote location 36 and supports an operation by the operator.

In the field 34, a three-dimensional orthogonal coordinate system 42 for tracking whose origin 40 is set at a predetermined position is set in advance. For example, a vertex or the like of the object 38 is defined as the origin 40. The three-dimensional orthogonal coordinate system 42 is a coordinate system defined in the real space.

A three-dimensional virtual space 44 is set on the supporter apparatus 12. A three-dimensional orthogonal coordinate system 46 is set in the three-dimensional virtual space 44. The three-dimensional orthogonal coordinate system 46 is a coordinate system defined in the virtual space. Data of a three-dimensional model 48 representing the object 38 is stored in advance in the memory 30 of the supporter apparatus 12. The three-dimensional model 48 is a virtual model present in the three-dimensional virtual space 44. A three-dimensional orthogonal coordinate system 50 corresponding to the three-dimensional orthogonal coordinate system 42 set in the field 34 is defined in the three-dimensional virtual space 44. An origin 52 of the three-dimensional orthogonal coordinate system 50 corresponds to the origin 40 of the three-dimensional orthogonal coordinate system 42. The three-dimensional orthogonal coordinate system 50 may be a coordinate system that matches the three-dimensional orthogonal coordinate system 46.

The positional information acquisition unit 18 of the operator apparatus 10 acquires positional information and posture information on the operator apparatus 10. The positional information is information indicating the position of the operator apparatus 10 in the real three-dimensional space and is defined by the three-dimensional orthogonal coordinate system 42 based on the origin 40. The posture information is information indicating the posture of the operator apparatus 10 (for example, the orientation and tilt of the operator apparatus 10) in the real three-dimensional space.

The processor 24 of the operator apparatus 10 transmits the positional information and the posture information on the operator apparatus 10 to the supporter apparatus 12. Furthermore, when an image is captured by the photographing device 14, the processor 24 of the operator apparatus 10 transmits data of the image to the supporter apparatus 12.

The processor 32 of the supporter apparatus 12 receives the positional information and the posture information on the operator apparatus 10 from the operator apparatus 10.

The processor 32 arranges a virtual camera 54 representing the operator apparatus 10 in the three-dimensional virtual space 44. The virtual camera 54 is a virtual object representing the operator apparatus 10. As described later, the processor 32 arranges the virtual camera 54 with the posture designated by the supporter at the position designated by the supporter in the three-dimensional virtual space 44. Thus, the position and the posture of the operator apparatus 10 are designated by the supporter. The processor 32 transmits positional information indicating the designated position and posture information indicating the designated posture to the operator apparatus 10. As described above, the position and the posture of the operator apparatus 10 in the real space are designated by the supporter.

A screen 56, a screen 58, and a screen 60 are displayed on a display 28a of the UI 28 of the supporter apparatus 12.

The screen 56 is a screen on which an image of the field 34 is displayed. An image captured by the photographing device 14 of the operator apparatus 10 is displayed on the screen 56. When receiving data of the image captured by the photographing device 14 from the operator apparatus 10, the processor 32 of the supporter apparatus 12 displays the image on the screen 56. For example, in the case where the operator is wearing the HMD as the operator apparatus 10 on the head, an image representing the field of view of the operator is displayed on the screen 56.

The screen 58 is a screen on which an image overlooking the three-dimensional virtual space 44 is displayed. For example, in the case where the three-dimensional model 48 and the virtual camera 54 are arranged in the three-dimensional virtual space 44, the processor 32 displays on the screen 58 an image overlooking the three-dimensional model 48 and the virtual camera 54. The supporter is able to understand the positional relationship between the three-dimensional model 48 and the virtual camera 54, the posture of the virtual camera 54 with respect to the three-dimensional model 48, and the like by referencing the image displayed on the screen 58.

The screen 60 is a screen on which a field of view in the three-dimensional virtual space 44 is displayed. Specifically, based on the position of the virtual camera 54 in the three-dimensional virtual space 44 as a viewpoint from which a target is seen, the processor 32 displays on the screen 60 a model arranged within the field of view from the viewpoint in the three-dimensional virtual space 44. That is, the processor 32 displays on the screen 60 a model (for example, the three-dimensional model 48) seen from the virtual camera 54 in the three-dimensional virtual space 44. When the supporter changes the position and the posture of the virtual camera 54 in the three-dimensional virtual space 44, the processor 32 displays on the screen 60 a model in the three-dimensional virtual space 44 seen from the changed position and with the changed posture.

A process performed when the supporter supports an operation by the operator will be described below with reference to FIG. 5. FIG. 5 illustrates the field 34 and the remote location 36, as in FIG. 4.

The supporter references the screens 58 and 60 to provide guide to the position and the sight direction of the operator. Specifically, the supporter operates the field of view of the virtual camera 54 in the three-dimensional virtual space 44 by using the UI 28 of the supporter apparatus 12. For example, the supporter operates, using the UI 28, the virtual camera 54 in the three-dimensional virtual space 44 to designate the position and the posture of the virtual camera 54. In accordance with changes in the position and the posture of the virtual camera 54 due to the operation by the supporter, the position and the posture of the virtual camera 54 displayed on the screen 58 are changed. Furthermore, since the viewpoint of the virtual camera 54 and the field of view from the viewpoint change, display contents on the screen 60 also change. For example, the position and the angle at which the three-dimensional model 48 is seen change. As described above, the supporter operates the virtual camera 54 to designate the position at which the operator apparatus 10 (that is, the operator who is wearing the operator apparatus 10) is to be arranged and the posture that the operator apparatus 10 is to have at the position, and guides the operator to the position and the posture.

When the supporter provides, using the UI 28, an instruction for transmission of positional information and posture information of the virtual camera 54, the processor 32 receives a designation of display contents on the screen 60 and transmits instruction information including the positional information and the posture information to the operator apparatus 10. The position indicated by the positional information is a position corresponding to the position at which the operator apparatus 10 is to be arranged in the real space. The posture indicated by the posture information is a posture corresponding to the posture that the operator apparatus 10 is to have in the real space. For example, when the display contents on the screen 60 become what are intended by the supporter, the supporter is supposed to provide an instruction for transmission of positional information and posture information of the virtual camera 54 at that time.

When receiving the instruction information transmitted from the supporter apparatus 12, the processor 24 of the operator apparatus 10 virtually displays, via the display of the UI 20 of the operator apparatus 10, information indicating the position and the posture of the operator apparatus 10 corresponding to the display contents designated on the screen 60. For example, the processor 24 displays, via the display of the UI 20, a virtual object with the posture corresponding to the posture of the virtual camera 54 at the position with respect to the object 38, the position corresponding to the position of the virtual camera 54 with respect to the three-dimensional model 48 in the three-dimensional virtual space 44. The virtual object is an image or a character string representing the position and the posture designated by the supporter. For example, the processor 24 displays, using augmented reality (AR) technology or mixed reality (MR) technology, the visual object to be superimposed on the real scene.

FIG. 5 schematically illustrates a display region 62 for AR display. The display region 62 is a region formed on the display of the HMD as the operator apparatus 10. An image captured by the photographing device 14 of the operator apparatus 10 and a virtual object 64 are displayed in the display region 62. The processor 24 displays the virtual object 64 with the posture indicated by the posture information included in the instruction information at the position indicated by the positional information included in the instruction information.

Furthermore, since the virtual object 64 is displayed in the display region 62, the virtual object 64 is also displayed on the screen 56.

The position indicated by sign 66 is a position in the real space that corresponds to the position of the virtual camera 54 in the three-dimensional virtual space 44. That is, the position indicated by the sign 66 is the position at which the operator apparatus 10 is to be arranged in the real space.

For example, the supporter guides in real time the operator to the position and the posture of the operator. That is, when the supporter operates the UI 28 of the supporter apparatus 12 to change the position and the posture of the virtual camera 54 in the three-dimensional virtual space 44, the position and the posture of the virtual object 64 change following the changes in the position and the posture of the virtual camera 54, and the virtual object 64 is AR-displayed in the display region 62. That is, the instruction information is transmitted in real time from the supporter apparatus 12 to the operator apparatus 10, and the virtual object 64 is displayed based on the instruction information.

As another example, when the supporter presses a transmission button on the UI 28 of the supporter apparatus 12, instruction information including positional information indicating the position of the virtual camera 54 at that time and posture information indicating the posture of the virtual camera 54 at that time may be transmitted from the supporter apparatus 12 to the operator apparatus 10. On the operator apparatus 10, the virtual object 64 is displayed based on the instruction information. The supporter may designate a plurality of positions and a plurality of postures of the virtual camera 54 at the same time or in turn. In this case, instruction information including positional information indicating each of the positions and posture information indicating each of the postures is transmitted from the supporter apparatus 12 to the operator apparatus 10. The processor 24 of the operator apparatus 10 displays virtual objects with postures corresponding to the plurality of postures at positions corresponding to the plurality of positions in the display region 62 at the same time or in turn. The processor 24 may display virtual objects in accordance with a designated order or may display the virtual objects in different colors. For example, in the case where the operator is expected to operate at a plurality of positions in turn, the supporter may guide the operator by designating the plurality of positions in turn.

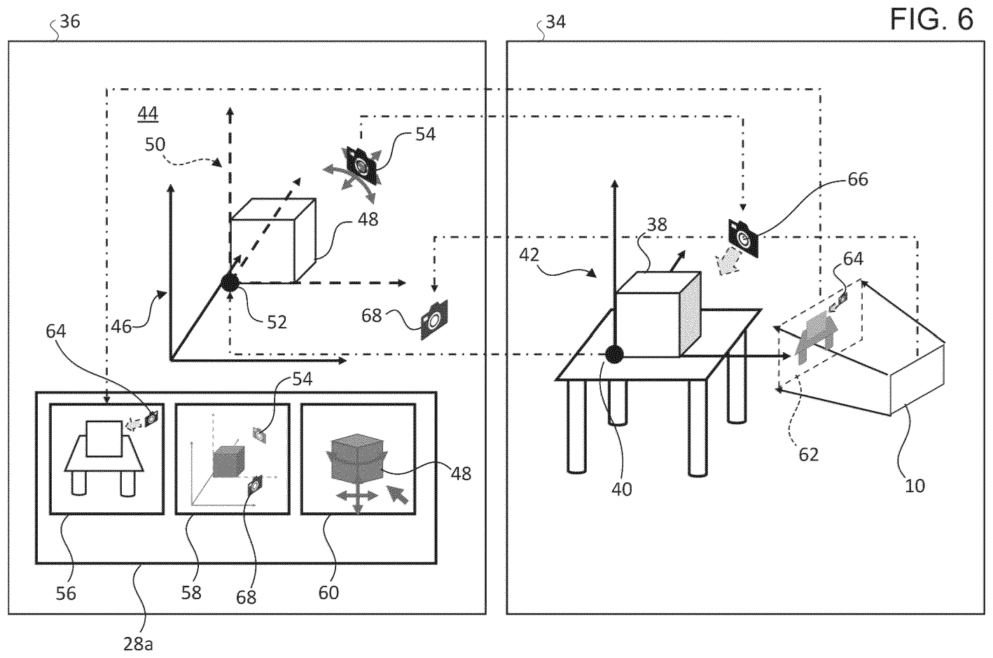

Modifications will be described below with reference to FIG. 6. FIG. 6 illustrates the field 34 and the remote location 36, as in FIG. 4.

The processor 32 of the supporter apparatus 12 arranges, in the three-dimensional virtual space 44, a three-dimensional model 68 representing the operator apparatus 10 with the posture of the operator apparatus 10 in the real space at the position corresponding to the position of the operator apparatus 10 in the real space. On the screen 58 indicating a bird's eye view, the three-dimensional model 68 is displayed. Thus, the supporter is able to determine whether or not the operator apparatus 10 is close to the position designated by the supporter and determine whether or not the posture designated by the supporter and the posture of the operator apparatus 10 match.

In the case where the difference between the position and the posture of the operator apparatus 10 corresponding to the display contents on the screen 60 and the position and the posture of the operator apparatus 10 in the real space is less than or equal to a threshold, the processor 32 of the operator apparatus 10 outputs information indicating that the difference is less than or equal to the threshold.

Specifically, the positional information indicating the position of the operator apparatus 10 in the real space and posture information indicating the posture of the operator apparatus 10 in the real space are transmitted from the operator apparatus 10 to the supporter apparatus 12. The processor 32 of the supporter apparatus 12 receives the positional information and the posture information. The processor 32 calculates the difference between the position of the operator apparatus 10 designated by the supporter on the supporter apparatus 12 and the position of the operator apparatus 10 in the real space. Similarly, the processor 32 calculates the difference between the posture of the operator apparatus 10 designated by the supporter on the supporter apparatus 12 and the posture of the operator apparatus 10 in the real space. In the case where the differences are less than or equal to the threshold, the processor 32 outputs information indicating that the differences are less than or equal to the threshold. For example, the processor 32 displays, on the display of the UI 28 of the supporter apparatus 12, information indicating that the operator apparatus 10 is close to the position designated by the supporter or information indicating that the operator apparatus 10 is arranged at the position designated by the supporter. Furthermore, the processor 32 displays, on the display of the UI 28, information indicating that the posture of the operator apparatus 10 is close to the posture designated by the supporter or information indicating that the posture designated by the supporter and the posture of the operator apparatus 10 match.

Regardless of the posture of the operator apparatus 10 in the real space, in the case where the difference between the position of the operator apparatus 10 designated by the supporter and the position of the operator apparatus 10 in the real space is less than or equal to the threshold, the processor 32 of the supporter apparatus 12 may output information indicating that the difference is less than or equal to the threshold. The same applies to posture.

The processor 24 of the operator apparatus 10 may AR-display, in the display region 62, information indicating a path from the position of the operator apparatus 10 in the real space to the position indicated by the positional information included in the instruction information transmitted from the supporter apparatus 12. For example, the processor 24 AR-displays, in the display region 62, an image (for example, an image of an arrow) for guiding the operator from the position of the operator apparatus 10 in the real space to the position designated by the supporter.

Furthermore, in the case where the difference between the position and the posture of the operator apparatus 10 corresponding to the display contents on the screen 60 and the position and the posture of the operator apparatus 10 in the real space is less than or equal to the threshold, the processor 24 of the operator apparatus 10 may output information indicating that the difference is less than or equal to the threshold.

Specifically, the processor 24 of the operator apparatus 10 calculates the difference between the position of the operator apparatus 10 designated by the supporter on the supporter apparatus 12 (that is, the position indicated by positional information included in instruction information) and the position of the operator apparatus 10 in the real space. Similarly, the processor 24 calculates the difference between the posture of the operator apparatus 10 designated by the supporter on the supporter apparatus 12 (that is, the posture indicated by posture information included in instruction information) and the posture of the operator apparatus 10 in the real space. In the case where these differences are less than or equal to the threshold, the processor 24 outputs information indicating that the differences are less than or equal to the threshold. For example, the processor 24 AR-displays, in the display region 62 of the operator apparatus 10, information indicating that the operator apparatus 10 is close to the position designated by the supporter or information indicating that the operator apparatus 10 is arranged at the position designated by the supporter. The processor 24 also AR-displays, in the display region 62, information indicating that the posture of the operator apparatus 10 is close to the posture designated by the supporter or information indicating that the posture designated by the supporter and the posture of the operator apparatus 10 match.

Regardless of the posture of the operator apparatus 10 in the real space, in the case where the difference between the position of the operator apparatus 10 designated by the supporter and the position of the operator apparatus 10 in the real space is less than or equal to the threshold, the processor 24 of the operator apparatus 10 may AR-display information indicating that the difference is less than or equal to the threshold. The same applies to posture.

In the case where a plurality of positions are designated by the supporter, if the operator apparatus 10 is not arranged at all the designated positions in the real space, the processor 24 of the operator apparatus 10 may AR-display warning information or the processor 32 of the supporter apparatus 12 may output warning information. For example, in the case where five positions are designated by the supporter, if the operator apparatus 10 is arranged at only four of the five positions in turn, warning information is output. In the case where the order of the plurality of positions is designated, if the operator apparatus 10 is not arranged at the positions in accordance with the designated order, warning information may be output.

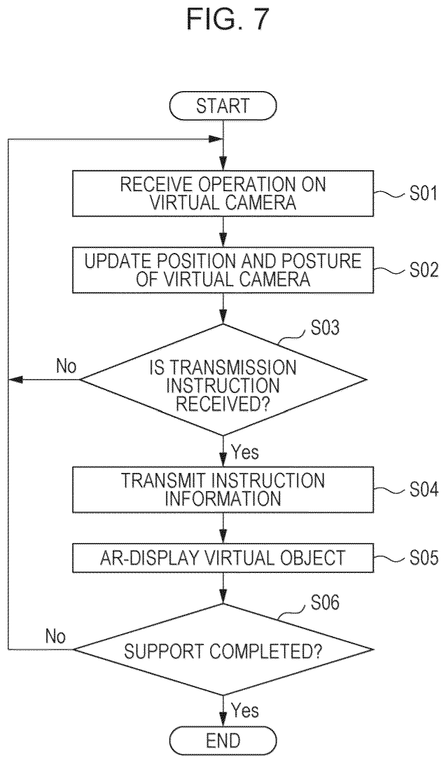

A process performed by the information processing system will be described below with reference to FIG. 7. FIG. 7 is a flowchart illustrating the flow of the process.

The processor 32 of the supporter apparatus 12 receives an operation on the virtual camera 54 by the supporter (S01), and updates the position and the posture of the virtual camera 54 in the three-dimensional virtual space 44 in accordance with the operation (S02). In the case where the processor 32 receives an instruction for transmission of instruction information (in S03, Yes), the processor 32 transmits instruction information including positional information and posture information on the virtual camera 54 to the operator apparatus 10 (S04). In the case where the processor 32 does not receive an instruction for transmission of instruction information (in S03, No), the process returns to step S01. The processor 24 of the operator apparatus 10 AR-displays, based on the instruction information transmitted from the supporter apparatus 12, the virtual object 64 with the posture designated by the supporter at the position designated by the supporter (S05). In the case where support by the supporter is completed (S06, Yes), the process ends. In the case where support by the supporter is not completed (S06, No), the process proceeds to step S01.

The functions of the operator apparatus 10 and the supporter apparatus 12 are implemented by, for example, cooperation between hardware and software. For example, the functions of the operator apparatus 10 are implemented when the processor 24 of the operator apparatus 10 reads and executes a program stored in the memory. The program is stored in the memory via a recording medium such as a compact disc (CD) or a digital versatile disc (DVD) or via a communication path such as a network. Similarly, the functions of the supporter apparatus 12 are implemented when the processor 32 of the supporter apparatus 12 reads and executes a program stored in the memory. The program is stored in the memory via a recording medium such as a CD or a DVD or via a communication path such as a network.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1)))

An information processing system comprising:
an operator apparatus that photographs an object; and
a supporter apparatus that supports an operation by an operator who uses the operator apparatus,
wherein the supporter apparatus includes a first processor,
wherein the operator apparatus includes a second processor,
wherein the first processor is configured to:
   perform control in such a manner that a first screen representing a three-dimensional model of the object is displayed on a display device; and
   receive a designation of display contents on the first screen, and
wherein the second processor is configured to:
   virtually display, via the operator apparatus, information indicating a position and a posture of the operator apparatus corresponding to the display contents designated on the first screen.
      (((2)))

The information processing system according to (((1))), wherein the first processor is further configured to:
perform control in such a manner that a second screen representing a virtual space including the three-dimensional model is displayed on the display device; and
display on the second screen a virtual object for the operator apparatus that reflects a position and a posture of the operator apparatus in a real space.
   (((3)))

The information processing system according to (((1))), wherein the first processor is further configured to, in a case where a difference between a position and a posture of the operator apparatus corresponding to the display contents on the first screen and a position and a posture of the operator apparatus in a real space is less than or equal to a threshold, output information indicating that the difference is less than or equal to the threshold.

(((4)))

The information processing system according to any one of (((1))) to (((3))), wherein the second processor is further configured to virtually display, via the operator apparatus, information indicating a path from a position of the operator apparatus in a real space and a position in the real space corresponding to the display contents on the first screen.

(((5)))

The information processing system according to any one of (((1))) to (((4))), wherein the second processor is further configured to, in a case where a difference between a position and a posture corresponding to the display contents on the first screen and a position and a posture of the operator apparatus in a real space is less than or equal to a threshold, output information indicating that the difference is less than or equal to the threshold.

(((6)))

An information processing system comprising:
a processor; and
a display,
wherein the processor is configured to:
   acquire an image of an object from an operator apparatus that photographs the object;
   perform control in such a manner that a first screen representing a three-dimensional model of the object is displayed on the display;
   receive a designation of display contents on the first screen; and
   transmit information indicating a position and a posture of the operator apparatus corresponding to the display contents designated on the first screen to the operator apparatus.
      (((7)))

A program for causing a computer to execute a process comprising:
performing control in such a manner that a first screen representing a three-dimensional model of an object photographed by an operator apparatus is displayed on a display device for a supporter who supports an operation by an operator who uses the operator apparatus;
receiving a designation of display contents on the first screen; and
virtually displaying, via the operator apparatus, information indicating a position and a posture of the operator apparatus corresponding to the display contents designated on the first screen.

What is claimed is:

1. An information processing system comprising:
an operator apparatus that photographs an object; and
a supporter apparatus that supports an operation by an operator who uses the operator apparatus,
wherein the supporter apparatus includes a first processor,
wherein the operator apparatus includes a second processor,
wherein the first processor is configured to:
perform control in such a manner that a first screen representing a three-dimensional model of the object is displayed on a display device; and
receive a designation of display contents on the first screen, and
wherein the second processor is configured to virtually display, via the operator apparatus, information indicating a position and a posture of the operator apparatus corresponding to the display contents designated on the first screen.

2. The information processing system according to claim 1, wherein the first processor is further configured to:
perform control in such a manner that a second screen representing a virtual space including the three-dimensional model is displayed on the display device; and
display, on the second screen, a virtual object for the operator apparatus that reflects a position and a posture of the operator apparatus in a real space.

3. The information processing system according to claim 1, wherein the first processor is further configured to, in a case where a difference between a position and a posture of the operator apparatus corresponding to the display contents on the first screen and a position and a posture of the operator apparatus in a real space is less than or equal to a threshold, output information indicating that the difference is less than or equal to the threshold.

4. The information processing system according to claim 1, wherein the second processor is further configured to virtually display, via the operator apparatus, information indicating a path from a position of the operator apparatus in a real space to a position in the real space corresponding to the display contents on the first screen.

5. The information processing system according to claim 2, wherein the second processor is further configured to virtually display, via the operator apparatus, information indicating a path from a position of the operator apparatus in a real space to a position in the real space corresponding to the display contents on the first screen.

6. The information processing system according to claim 3, wherein the second processor is further configured to virtually display, via the operator apparatus, information indicating a path from a position of the operator apparatus in a real space to a position in the real space corresponding to the display contents on the first screen.

7. The information processing system according to claim 1, wherein the second processor is further configured to, in a case where a difference between a position and a posture corresponding to the display contents on the first screen and a position and a posture of the operator apparatus in a real space is less than or equal to a threshold, output information indicating that the difference is less than or equal to the threshold.

8. The information processing system according to claim 2, wherein the second processor is further configured to, in a case where a difference between a position and a posture corresponding to the display contents on the first screen and a position and a posture of the operator apparatus in a real space is less than or equal to a threshold, output information indicating that the difference is less than or equal to the threshold.

9. The information processing system according to claim 3, wherein the second processor is further configured to, in a case where a difference between a position and a posture corresponding to the display contents on the first screen and a position and a posture of the operator apparatus in a real space is less than or equal to a threshold, output information indicating that the difference is less than or equal to the threshold.

10. An information processing system comprising:
a processor configured to:
acquire an image of an object from an operator apparatus that photographs the object;
perform control in such a manner that a first screen representing a three-dimensional model of the object is displayed on a display device;
receive a designation of display contents on the first screen; and
transmit information indicating a position and a posture of the operator apparatus corresponding to the display contents designated on the first screen to the operator apparatus.

11. A non-transitory computer readable medium storing a program causing a computer to execute a process comprising:
performing control in such a manner that a first screen representing a three-dimensional model of an object photographed by an operator apparatus is displayed on a display device for a supporter who supports an operation by an operator who uses the operator apparatus;
receiving a designation of display contents on the first screen; and
virtually displaying, via the operator apparatus, information indicating a position and a posture of the operator apparatus corresponding to the display contents designated on the first screen.
